(19) United States
(12) Patent Application Publication
(10) Pub. No.: US 2026/0188812 A1
(43) Pub. Date: Jul. 2, 2026

(54) BATTERY ASSEMBLY AND BATTERY CONTAINER INCLUDING THE BATTERY ASSEMBLY

(71) Applicant: SAMSUNG SDI CO., LTD., Yongin-si (KR)

(72) Inventor: Byunghwa JUNG, Yongin-si (KR)

(21) Appl. No.: 19/321,459

(22) Filed: Sep. 8, 2025

(30) Foreign Application Priority Data
Jan. 2, 2025 (KR) 10-2025-0000450

(51) Int. Cl. H01M 50/24; A62C 3/16; H01M 10/42; H01M 10/613; H01M 10/647; H01M 10/656; H01M 50/209; H01M 50/262; H01M 50/289; H01M 50/507

(52) U.S. Cl. CPC H01M 50/24; A62C 3/16; H01M 10/425; H01M 10/613; H01M 10/647; H01M 10/656; H01M 50/209; H01M 50/262; H01M 50/289; H01M 50/507; H01M 2010/4271

(57) ABSTRACT

A battery assembly includes a case accommodating a plurality of battery cells. A pusher is coupled to an inside of the case and configured to push the plurality of battery cells.

### CROSS-REFERENCE TO RELATED APPLICATION

The present application claims priority to and the benefit of Korean Application No. 10-2025-0000450, filed on Jan. 2, 2025, in the Korean Intellectual Property Office, the entire disclosure of which is incorporated by reference herein.

### BACKGROUND

### Field

The present disclosure relates to a battery assembly and a battery container including the battery assembly.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

An energy storage system (ESS, Energy Storage System) refers to a system that stores electric energy by using a lithium-ion battery or the like such that the stored energy may be used when necessary. With a energy storage system, energy may be efficiently utilized in all stages of power generation, transmission, substations, distribution, and reception.

An energy storage system may be made in the form of a container. Such a battery container may include a battery rack having a shelf-like support structure in which a plurality of battery modules is mounted according to customer requirements. Here, each battery module may accommodate a plurality of secondary batteries electrically connected in series and/or in parallel. Such a battery container may have a complex structure due to building a support structure by stages (i.e., battery cells, battery modules, battery racks, etc.) and wiring. Thus, quality control and maintenance of the energy storage system may be difficult.

The above information disclosed in this Background section is for enhancement of understanding of the background of the present disclosure, and therefore, it may contain information that does not constitute related (or prior) art.

### SUMMARY

The present disclosure provides a battery assembly and a battery container including the battery assembly.

These and other aspects and features of the present disclosure will be described in or will be apparent from the following description of embodiments of the present disclosure.

According to an embodiment of the present disclosure, a battery assembly may include a case, a plurality of battery cells accommodated in the case and aligned in one direction, and a pusher coupled to an inside of the case and configured to push the plurality of battery cells in the one direction.

In some embodiments, the case may include a lower plate supporting lower portions of the battery cells, and a side plate coupled orthogonally to the lower plate and supporting side surfaces of the battery cells.

In some embodiments, the pusher is coupled to an inner surface of the side plate and is configured to push the plurality of battery cells in a direction facing the inner surface.

In some embodiments, the pusher may include a head contacting at least a portion of the plurality of battery cells, and an elastic member having a first end connected to the inner surface and a second end connected to the head, the elastic member being configured to provide a restoring force to the head.

In some embodiments, the lower plate may include a cooling portion and a support portion supporting the cooling portion.

In some embodiments, the cooling portion may include a plurality of cooling passages, with the cooling passages being spaced apart from each other and being configured to accommodate a coolant.

In some embodiments, the battery assembly further includes a plurality of bus bars configured to electrically connect the battery cells, a bus bar holder positioned above the plurality of battery cells and configured to support the plurality of bus bars, and a coupling member coupling the bus bar holder and the case.

In some embodiments, the coupling member detachably couples the plurality of bus bars, the bus bar holder, and the case.

In some embodiments, a first end of the coupling member is coupled to the bus bar holder, and a second end of the coupling member is inserted into and coupled to a coupling groove formed in the case.

In some embodiments, a battery container may include a plurality of battery assemblies, a plurality of slave battery management systems (BMSs) respectively controlling the plurality of battery assemblies, and a plurality of battery control devices connected to the plurality of slave BMSs, wherein each of the battery assemblies may include a plurality of battery cells aligned in a first direction, a case accommodating the plurality of battery cells, and a pusher coupled to an inside of the case and configured to push the plurality of battery cells in the first direction.

In some embodiments, the plurality of battery assemblies may include a first set of battery assemblies aligned in a second direction perpendicular to the first direction, and a second set of battery assemblies aligned in the second direction and disposed in a third direction with respect to the first set of battery assemblies, wherein the third direction is perpendicular to each of the first direction and the second direction, and wherein the plurality of slave BMSs may include a first set of slave BMSs arranged on a front surface of each of the first set of battery assemblies and connected in the second direction, and a second set of slave BMSs arranged on a front surface of each of the second set of battery assemblies and connected in the second direction.

In some embodiments, the plurality of battery control devices may include a first battery control device connected in the second direction to the first set of slave BMSs, and a second battery control device connected in the second direction to the second set of slave BMSs.

In some embodiments, the first battery control device and the second battery control device are arranged and connected in the third direction.

In some embodiments, the first battery control device is arranged at a center of the first set of battery assemblies aligned in the second direction, and the second battery control device is arranged at a center of the second set of battery assemblies aligned in the second direction.

In some embodiments, the battery container further includes a fire extinguishing device accommodating a fire extinguishing agent, and wherein, in response to detecting a fire occurring in at least a portion of the plurality of battery assemblies, the plurality of battery control devices is configured to control the fire extinguishing device to spray the fire extinguishing agent onto the plurality of battery assemblies.

In some embodiments, each of the plurality of battery control devices may include a master BMS configured to control at least a portion of the plurality of slave BMSs, and a power control unit configured to control power supplied to at least a portion of the plurality of battery assemblies.

In some embodiments, the battery container further includes a support member supporting lower portions of the battery assemblies, wherein the support member may include a cooling portion configured to cool the plurality of battery assemblies.

In some embodiments, the plurality of battery assemblies may include a first battery assembly, and a second battery assembly aligned in a second direction with respect to the first battery assembly, wherein the second direction is perpendicular to the first direction, and wherein the cooling portion extends in the second direction to cool the first battery assembly and the second battery assembly.

In some embodiments, the case may include a lower plate supporting lower portions of the battery cells, and a side plate coupled orthogonally to the lower plate and supporting side surfaces of the battery cells.

In some embodiments, the pusher is coupled to an inner surface of the side plate and is configured to push the plurality of battery cells in a direction facing the inner surface.

According to embodiments of the present disclosure, a battery cell may be inserted into the case while pushing rearward on a plurality of battery cells already accommodated in the case. With this configuration, the plurality of battery cells may be easily mounted in the case.

According to embodiments of the present disclosure, the bus bar holder may be detachably coupled through the coupling member with the case. Accordingly, the process of welding the case and the bus bar holder may be omitted. In addition, if a problem occurs in a battery cell or a bus bar, the bus bar holder may be detached so that the battery cell or bus bar may be easily replaced.

According to embodiments of the present disclosure, by omitting a battery module including the plurality of battery cells and a battery rack including the plurality of battery modules, the battery container may be constructed using the plurality of battery cells. In addition, the structure of an energy storage system that takes the form of a battery container may be simplified. Accordingly, quality control and maintenance of the energy storage system may be facilitated.

According to embodiments of the present disclosure, if a fire occurs in a specific battery assembly, a fire extinguishing agent may be sprayed at the container level. Accordingly, fire propagation between battery assemblies may be prevented.

According to embodiments of the present disclosure, a support member may cool the battery assembly while supporting the lower portion of the battery assembly. Accordingly, the plurality of battery assemblies may be cooled and the heat may be dispersed, thereby preventing temperature imbalance among the plurality of battery cells included in the battery container.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates an example of a battery cell according to an embodiment of the present disclosure.

FIG. 2 is a cross-sectional view of a battery cell according to an embodiment of the present disclosure.

FIG. 3 is an exploded perspective view of a battery assembly according to an embodiment of the present disclosure.

FIG. 4 illustrates an example of a pusher that pushes battery cells according to an embodiment of the present disclosure.

FIG. 5 illustrates an example of a lower plate according to an embodiment of the present disclosure.

FIG. 6 illustrates a bus bar holder coupled to a case according to an embodiment of the present disclosure.

FIG. 7A and FIG. 7B illustrate a bus bar holder coupled to a case according to an embodiment of the present disclosure.

FIG. 8 illustrates an example of a battery container according to an embodiment of the present disclosure.

FIG. 9 illustrates an example of a fire extinguishing device included in a battery container according to an embodiment of the present disclosure.

FIG. 10 illustrates an example of a support member of a battery container according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of local patent laws.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, the size and relative size of layers and regions shown in the figures may be exaggerated for clarity of description. That is, the size shown in the figures is only for ease of understanding and is not limited thereto. In addition, the same reference numerals throughout the entire specification refer to the same constituent elements.

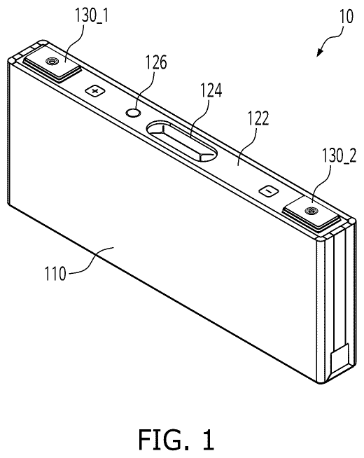

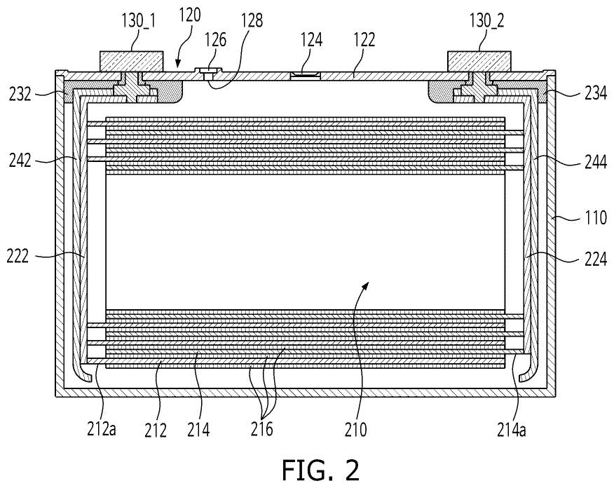

FIG. 1 illustrates an example of a battery cell 10 according to an embodiment of the present disclosure, and FIG. 2 is a cross-sectional view of a battery cell 10 according to an embodiment of the present disclosure. Referring to FIGS. 1 and 2, the secondary battery 10 according to one or more embodiments of the present disclosure may include at least one electrode assembly 210 in which a separator 216 serving as an insulator is interposed between a positive electrode 212 and a negative electrode 214, a case 110 accommodating the electrode assembly 210 therein, and a cap assembly 120 coupled to an opening of the case 110.

The secondary battery 10 according to one or more embodiments will now be described as an example of a prismatic lithium ion secondary battery. However, the present disclosure is not limited thereto, and suitable aspects, features and principles described herein may be applied to various other types of batteries, such as lithium polymer batteries and/or cylindrical batteries.

Each of the positive electrode 212 and the negative electrode 214 may include a current collector made of a thin metal foil having a coated portion on which an active material is coated and an uncoated portion 212a, 214a on which an active material is not coated.

The positive electrode 212 and the negative electrode 214 are wound after interposing the separator 216, which is an insulator, therebetween. However, the present disclosure is not limited thereto, and the electrode assembly 210 may have a structure in which a positive electrode 212 and a negative electrode 214, each made of a plurality of sheets, are alternately stacked with a separator interposed therebetween.

The case 110 may form the overall outer appearance of the secondary battery 10 and may be made of a conductive metal, such as aluminum, aluminum alloy, or nickel-plated steel. In addition, the case 110 may provide a space in which the electrode assembly 210 is accommodated.

The cap assembly 120 may include a cap plate 122 covering an opening in the case 110, and the case 110 and the cap plate 122 may be made of a conductive material. The positive and negative electrode terminals 130_1 and 130_2 electrically connected to the positive electrode 212 and the negative electrode 214, respectively, may be installed to penetrate (or extend through) the cap plate 122 and protrude outwardly therethrough.

In addition, outer peripheral surfaces (e.g., circumferential surfaces) of upper pillars of the positive and negative electrode terminals 130_1 and 130_2 protruding outwardly from the cap plate 122 may be threaded and may be fixed to the cap plate 122 by utilizing nuts.

However, the present disclosure is not limited thereto, and the positive and negative electrode terminals 130_1 and 130_2 may have a rivet structure and may be riveted or welded to the cap plate 122.

In addition, the cap plate 122 may be made of a thin plate and may be coupled to the opening in the case 110, and an electrolyte injection port 128 into which a sealing stopper 126 may be installed may be located (e.g., formed) in the cap plate 122, and a vent portion 124 having a notch may be installed.

The positive and negative electrode terminals 130_1 and 130_2 may be electrically connected to current collectors including first and second current collectors 222 and 224 (hereinafter referred to as positive and negative current collectors) by being bonded or coupled (e.g., by welding) to the positive uncoated portion 212a and the negative electrode uncoated portion 214a, respectively.

For example, the positive and negative electrode terminals 130_1 and 130_2 may be coupled by welding to the positive and negative electrode current collectors 222 and 224, respectively. However, the present disclosure is not limited thereto, and the positive and negative electrode terminals 130_1 and 130_2 and the positive and negative electrode current collectors 222 and 224 may be integrally formed in one or more embodiments.

In addition, an insulation member may be installed between the electrode assembly 210 and the cap plate 122. The insulation member may include first and second lower insulation members 232 and 234, and each of the first and second lower insulation members 232 and 234 may also have a portion located between the electrode assembly 210 and the case 110.

In addition, according to one or more embodiments of the present disclosure, one end of a separation member may face one side of the electrode assembly 210 and may be installed between the insulation member and the positive or negative electrode terminals 130_1 and 130_2.

In one or more embodiments, the separation member may include first and second separation members 242 and 244.

In such an embodiment, first ends of the first and second separation members 80 and 90 installed to face one side of the electrode assembly 210 may be respectively installed between the first and second lower insulation members 232 and 234 and the positive and negative electrode terminals 130_1 and 130_2.

Accordingly, the positive and negative electrode terminals 130_1 and 130_2, which may be coupled by welding to the positive and negative electrode current collectors 222 and 224, may be coupled to first ends of the first and second lower insulation members 232 and 234 and the first and second separation members 242 and 244.

The battery cell 10 may be a lithium battery cell, a sodium battery cell, or the like. However, the scope of the present disclosure is not limited to such examples, and the battery cell 10 may include any cell capable of repeatedly providing electricity by charging and discharging. In embodiments where the battery cell 10 is a lithium battery cell, it may be used in an electric vehicle (EV) due to excellent lifespan and high-rate characteristics. As another example, the lithium battery cell may be used in a hybrid vehicle such as a plug-in hybrid electric vehicle (PHEV). In addition, the lithium battery cell may be used in fields requiring a large amount of power storage. For example, the lithium battery cell may be used in electric bicycles, electric power tools, energy storage systems (ESS), and the like.

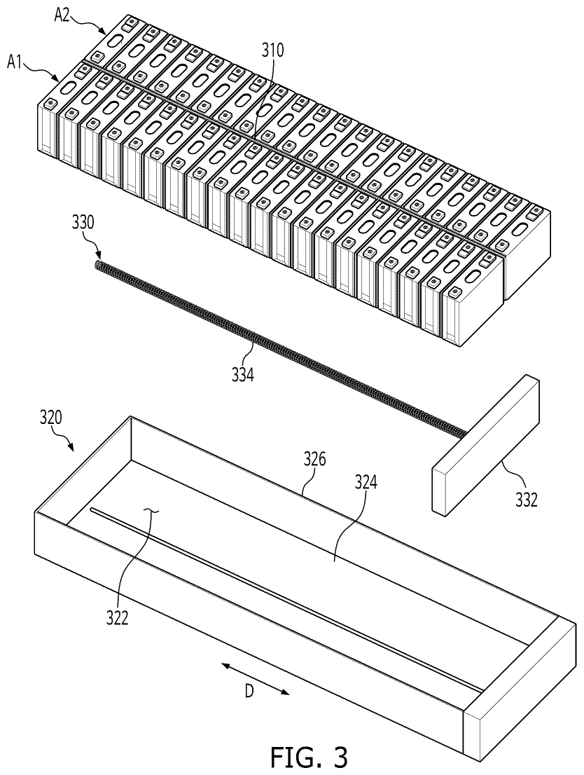

FIG. 3 is an exploded perspective view of a battery assembly according to an embodiment of the present disclosure. In one embodiment, the battery assembly may include a plurality of battery cells (for example, battery cells 10 of FIG. 1) 310, a case 320 accommodating the plurality of battery cells 310, and a pusher 330 coupled to an inside of the case 320 to push the plurality of battery cells 310 in one direction. Here, the plurality of battery cells 310 disposed in an accommodation space 322 of the case 320 may be aligned in a lengthwise direction D of the case 320 with large surfaces of the battery cells 310 facing each other.

In embodiments, the plurality of battery cells 310 may be cylindrical, prismatic, pouch cells, or the like, and there is no limitation on the type or shape of the battery cells 310. In addition, the accommodation space 322 of the case 320 may be modified to various sizes and shapes according to the type and shape of the plurality of battery cells 310.

The plurality of battery cells 310 may be arranged in parallel along the lengthwise direction D of the case 320. There is no limitation on the number of battery cells 310 along the lengthwise direction D of the case 320, and the battery cells 310 arranged in parallel may form a first group of cells A1 and a second group of cells A2. In another example, the battery cells 310 may include more than two cell groups arranged in parallel. But the arrangement of the battery cells 310 is not limited to illustration shown in FIG. 3.

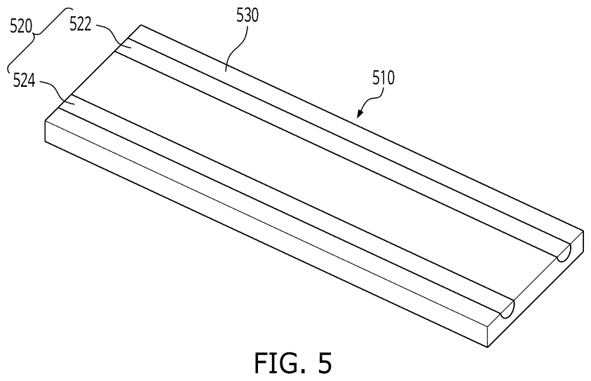

The case 320 may include a lower plate 324 supporting lower portions of the plurality of battery cells 310, and a side plate 326 coupled orthogonally to the lower plate 324 and supporting side surfaces of the plurality of battery cells 310. The lower plate 324 may include a cooling portion. An example of the lower plate 324 will be described below with reference to FIG. 5.

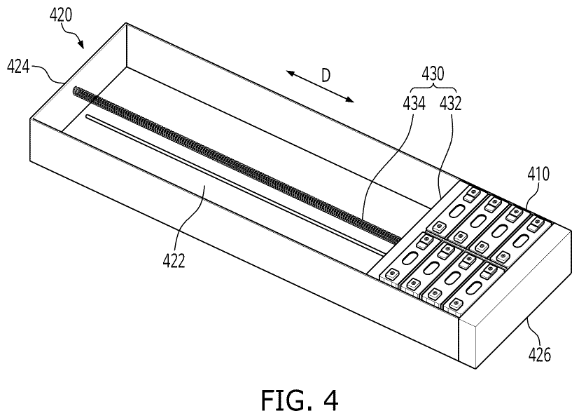

The pusher 330 may be coupled to an inner surface of the side plate 326 and may push the plurality of battery cells 310 in a direction facing the inner surface. The pusher 330 may include a head 332 contacting at least one of the battery cells 310 and an elastic member 334 having a first end connected to a rear portion of the inner surface of the side plate 326 and a second end connected to the head 332 to provide a restoring force to the head 332 in a direction toward a front portion of the inner surface of the side plate 326. In the depicted example, one end of the elastic member 334 is connected to the rear portion of the inner surface of the side plate 326 and the other end of the elastic member 334 contacts a rear portion of the plurality of battery cells 310 to push the battery cells 310 in a direction parallel to the lengthwise direction D of the case 320. The elastic member 334 may be a spring, but the present disclosure is not limited thereto. An example in which the pusher 330 pushes the battery cells 310 is described in detail below with reference to FIG. 4.

FIG. 4 shows an example in which a pusher 430 pushes a plurality of battery cells 410 according to an embodiment of the present disclosure. As in the embodiment described above with reference to FIG. 3, the battery cells 410 are accommodated in a case 420. Here, the case 420 may include a lower plate 422 supporting lower portions of the battery cells 410 and a side plate coupled orthogonally to the lower plate 422 and supporting the side surfaces of the plurality of battery cells 410. In addition, the side plate of the case 420 includes a rear plate 424 and a front plate 426 facing the rear plate 424. The front plate 426 may be thicker than the rear plate 424 to fasten a coupling member. But the present disclosure is not limited to such a configuration.

In an embodiment, the pusher 430 may be coupled to the inside of the case 420 to push the plurality of battery cells 410 in one direction. Specifically, the pusher 430 may include a head 432 contacting at least some of the battery cells 410 and an elastic member 434 disposed between the head 432 and the case 420. A first end of the elastic member 434 may be connected to the inside of the rear plate 424 and a second end of the elastic member 434 may be connected to the head 432 disposed at the rear side of the plurality of battery cells 410. Accordingly, the pusher 430 may push the plurality of battery cells 410 from the rear plate 424 toward the front plate 426 (i.e., in the lengthwise direction D of the case 420).

In FIG. 4, the vertical level of the front plate 426 is illustrated as being the same as the vertical level of the side plate (for example, the rear plate 424), but the present disclosure it is not limited to such a configuration. Here, the “vertical level” refers to a height in a direction perpendicular to a reference plane from the reference plane. For example, if the reference plane is a lower surface of the front plate 426, and the lower surface of the side plate and the lower surface of the front plate 426 have the same level, the vertical level (or height) of the front plate 426 may be smaller than that of the side plate.

With the configuration as described herein, a battery cell may be additionally inserted into the case while pushing rearward the plurality of battery cells already accommodated in the case. Thus, the battery cells may be easily mounted in the case.

FIG. 5 illustrates an example of a lower plate 510 according to an embodiment of the present disclosure. In an embodiment, the case (for example, the case 320 of FIG. 3) may include a lower plate 510 supporting lower portions of the battery cells. Here, the lower plate 510 may include a cooling portion 520 and a support portion 530 supporting the cooling portion 520. The cooling portion 520 may include a plurality of spaced apart cooling passages 522 and 524 for accommodating a coolant. As such, the cooling portion 520 may cool the plurality of battery cells from below the plurality of battery cells.

In FIG. 5, two cooling passages 522 and 524 are illustrated as being provided in the single lower plate 510, but the present disclosure is not limited to such a configuration. For example, the number of cooling passages may be changed based on the number of battery cells accommodated in the case, the degree of heat generation, etc. In addition, the shape of the cooling passages provided in the lower plate 510 is not limited to the depicted configuration, and a single cooling passage may be arranged in a circulating form.

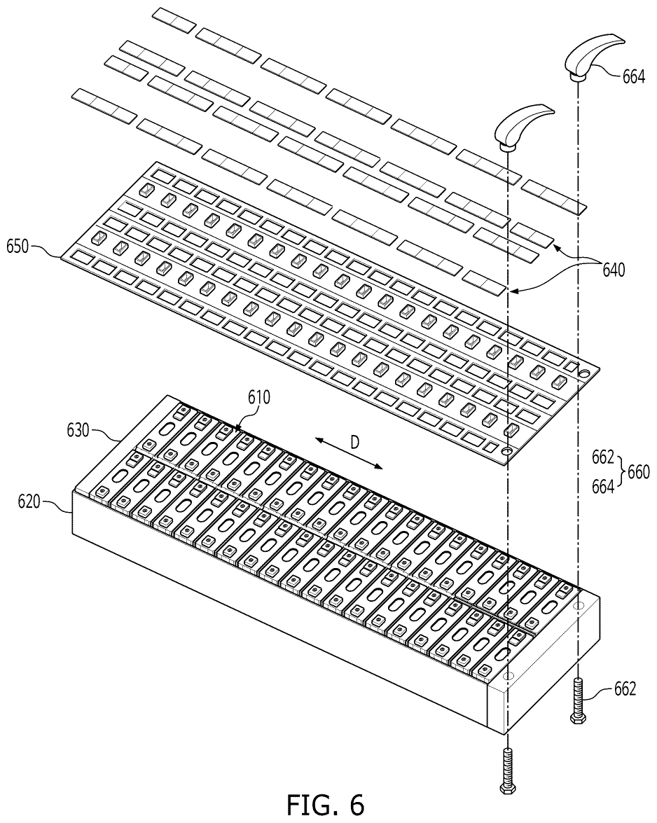

FIG. 6 illustrates an example in which a bus bar holder 650 is coupled to a case 620 according to an embodiment of the present disclosure. In an embodiment, the battery assembly may include a plurality of battery cells 610, a case 620 accommodating the plurality of battery cells 610, and a pusher 630 coupled to the inside of the case 620 that is configured to push the plurality of battery cells 610. The battery cells 610 may be aligned in a lengthwise direction of the case 620. The pusher 630 may be coupled to an inner surface of the case 620 to push the plurality of battery cells 610 in a direction facing the inner surface (i.e., the lengthwise direction of the case 620). For example, the pusher 630 may be coupled to a rear portion of the inner surface of the case 620 to push the plurality of battery cells 610 toward a front portion of the inner surface of the case 620.

In an embodiment, the battery assembly may further include a plurality of bus bars 640 electrically connecting the plurality of battery cells 610, a bus bar holder 650 positioned above the plurality of battery cells 610 and supporting the plurality of bus bars 640, and a coupling member 660 coupling the bus bar holder 650 and the case 620. Here, the coupling member 660 may detachably couple the bus bars 640, the bus bar holder 650, and the case 620. In the depicted example, the coupling member 660 includes a first coupling member 662 coupled from a lower side of the case 620, and a second coupling member 664 coupled to the first coupling member 662 at an upper side of the bus bar holder 650. The first coupling member 662 may be a long bolt, and the second coupling member 664 may be a hand-jack, but are the present disclosure not limited thereto. When the second coupling member 664 is coupled and fixed to the first coupling member 662, the bus bars 640, the bus bar holder 650, and the case 620 may be coupled and fixed together.

The bus bar holder 650 may be positioned above the plurality of battery cells 610 and may support the bus bars 640. The bus bar holder 650 may be, for example, a substantially rectangular plate, which may be made of an insulating material.

The bus bar holder 650 may include a plurality of through-holes exposing positive and negative terminals of the plurality of battery cells 610. A plurality of positive and negative terminals may be exposed through the plurality of through-holes formed in the bus bar holder 650, and the bus bars 640 may be electrically connected to the exposed positive and negative terminals.

The bus bars 640 may electrically connect the positive terminals and the negative terminals of each of the plurality of battery cells 610 in series and/or in parallel. To this end, a plurality of bus bars 640 may be provided. The bus bars 640 may be connected, for example, by welding to the positive and/or negative terminals. But the present disclosure is not limited thereto. Regions other than the positive terminals and the negative terminals of the plurality of battery cells 610 may be insulated from the bus bars 640 by the bus bar holder 650.

Although not illustrated in FIG. 6, the battery assembly may further include a circuit board above the bus bars 640. The circuit board may be configured to receive information on the plurality of battery cells 610 and control the plurality of battery cells 610. That is, the circuit board may be connected to the bus bars 640. In addition, although the coupling member 660 is illustrated in FIG. 6 as being coupled to a front portion of the case 620, the coupling member 600 is not limited thereto and it may also be coupled to a rear portion of the case 620.

With the depicted configuration, the bus bar holder may be detachably coupled to the case through the coupling member. Accordingly, the process of welding the case and the bus bar holder may be omitted. In addition, if a problem occurs in a battery cell or a bus bar, the bus bar holder may be detached so that the battery cell or bus bar may be easily replaced.

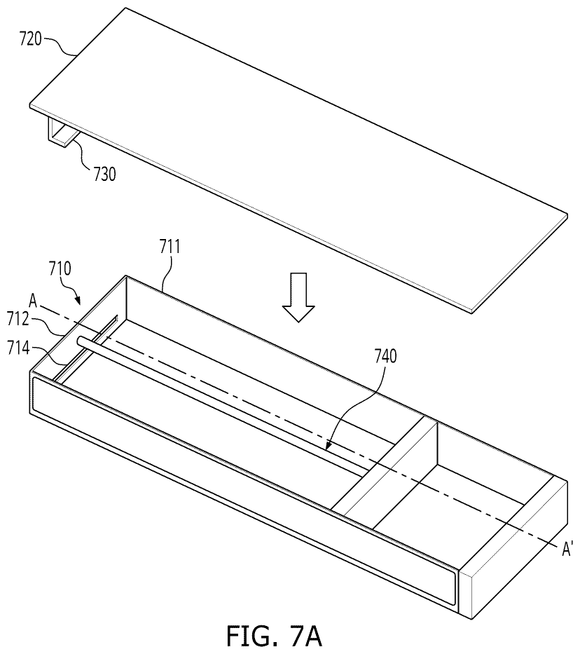

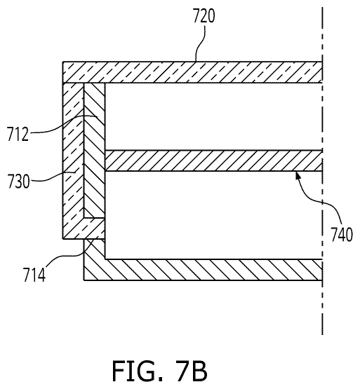

FIG. 7A illustrates an example in which a bus bar holder 720 is coupled to a case 710 according to an embodiment of the present disclosure, and FIG. 7B illustrates an example of a cross-section taken along line A-A′ of FIG. 7A. Referring to FIG. 7A, the bus bar holder 720 and the case 710 may be coupled by a coupling member 730. The case 710 may include a side plate 711 supporting side surfaces of the plurality of battery cells accommodated in an accommodation space inside the case 710. A coupling groove 714 may be formed in this side plate 711. For example, a coupling groove 714 may be formed in a rear plate 712 to which a pusher 740 is coupled.

Referring to FIG. 7B, a first end of the coupling member 730 may be coupled to the bus bar holder 720. The second end of the coupling member 730 may be bent toward the inside of the case 710. Accordingly, the second end of the coupling member 730 may be inserted and fitted into the coupling groove 714 formed in the case 710.

In FIG. 7A and FIG. 7B the coupling member 730 is illustrated as being coupled to a rear portion of the case 720, but the present disclosure is not limited thereto. A coupling groove may also be formed in a front portion of the case 720 so that a coupling member may be coupled thereto. Alternatively, the coupling member 660 described above with reference to FIG. 6 may be coupled to a front portion of the case 720.

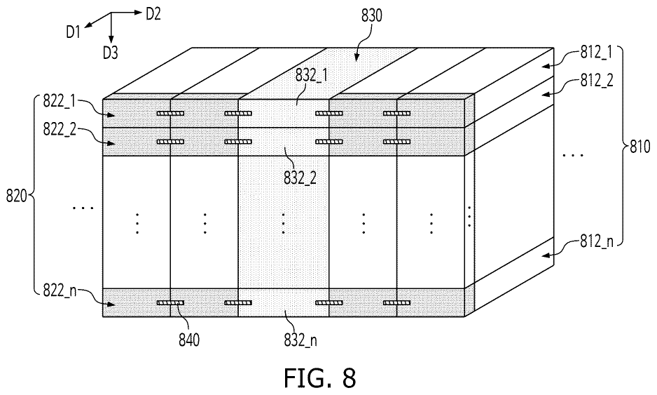

FIG. 8 illustrates an example of a battery container according to an embodiment of the present disclosure. The battery container may include a plurality of battery assemblies (each of which is, for example, the battery assembly of FIG. 3) 810, a plurality of BMSs (for example, a plurality of slave BMSs) 820 respectively controlling the plurality of battery assemblies 810. The battery container may also include a plurality of battery control devices 830 connected to the plurality of BMSs 820. Here, each battery assembly 810 of the plurality of battery assemblies may include a plurality of battery cells aligned in a first direction (i.e., direction D1), a case accommodating the plurality of battery cells, and a pusher coupled to an inside of the case and configured to push the plurality of battery cells in the first direction. The plurality of BMSs 820 may be arranged on the front surface of each battery assembly 810 of the plurality of battery assemblies 810, but the present disclosure is not limited to this arrangement.

The plurality of battery assemblies 810 may include a first set of battery assemblies 812_1 aligned in a second direction (i.e., direction D2) perpendicular to the first direction, and a second set of battery assemblies 812_2 to an n-th set of battery assemblies 812_n arranged in a third direction (i.e., direction D3) with respect to the first set of battery assemblies 812_1 and aligned in the second direction. The third direction is perpendicular to each of the first direction and the second direction.

The plurality of BMSs 820 may include first to n-th sets of BMSs 822_1 to 822_n, each arranged on a front surface of the first to n-th sets of battery assemblies 812_1 to 812_n, respectively, and connected in the second direction. A plurality of BMSs included in each of the first to n-th sets of BMSs 822_1 to 822_n may be connected in the second direction via a plurality of cables 840. The plurality of BMSs 820 may be connected to each of the battery assemblies 810 to receive information related to battery cells from the battery assemblies 810 and to control the battery assemblies 810 and the battery cells included in each of the battery assemblies 810.

The plurality of battery control devices 830 may include first to n-th battery control devices 832_1 to 832_n connected in the second direction to the first to n-th sets of BMSs 822_1 to 822_n, respectively. Here, each of the first to n-th battery control devices 832_1 to 832_n may be arranged and connected in the third direction. In addition, each of the first to n-th battery control devices 832_1 to 832_n may be arranged between the first set of battery assemblies 812_1 aligned in the second direction and the n-th set of battery assemblies 812_n aligned in the second direction.

Each of the plurality of battery control devices 830 may include a higher-level BMS (for example, a master BMS) controlling at least some of the plurality of BMSs 820, and a power control unit controlling power supplied to at least some of the battery assemblies 810. Accordingly, the battery control devices 830 may manage and control the battery cells included in the battery container.

FIG. 8 is simplified for clarity, and the present disclosure is not limited to the depicted configuration. A plurality of bus bars for high power and a plurality of cables for high power or communication may be connected in the same direction in which the plurality of BMSs 820 is connected.

By omitting a battery module including the plurality of battery cells and a battery rack including the plurality of battery modules, a battery container according to the present disclosure may be constructed using the plurality of battery cells. In addition, the structure of an energy storage system, which takes the form of a battery container, may be simplified. Accordingly, quality control and maintenance of the energy storage system may be facilitated.

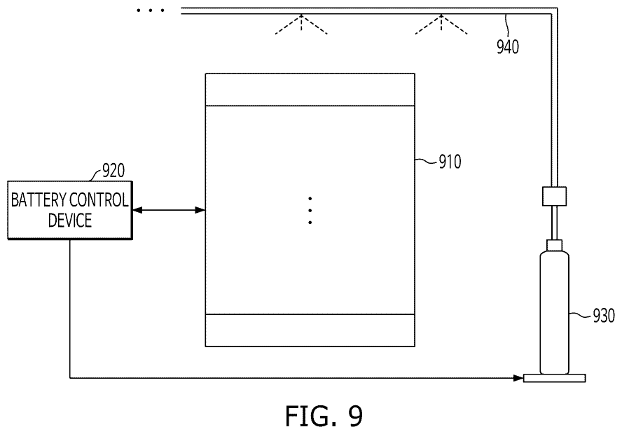

FIG. 9 illustrates an example of a fire extinguishing device 930 included in a battery container according to an embodiment of the present disclosure. The battery container may include a plurality of battery assemblies 910 and a battery control device (for example, 830 of FIG. 8) 920 configured to collectively monitor and control the plurality of battery assemblies 910. Here, the battery control device 920 may receive information related to a plurality of battery cells included in each of the plurality of battery assemblies 910. The battery control device 920 may detect a fire occurring in one or more of the battery assemblies 910 based on the information related to the plurality of battery cells. In response to detecting a fire, the battery control device 920 may control the fire extinguishing device 930 to spray a fire extinguishing agent onto the plurality of battery assemblies 910. In this case, the battery control device 920 may output information associated with the battery assembly or battery assemblies in which the fire is detected (for example, identification information or location of the battery assembly in which the fire is detected).

The fire extinguishing device 930 may accommodate the fire extinguishing agent. In response to receiving a command from the battery control device 920 to extinguish a fire, the fire extinguishing device 930 may open a main valve and discharge the fire extinguishing agent into an extinguishing pipe 940. This fire extinguishing agent may be transported to an upper side of the battery container through the extinguishing pipe 940. The fire extinguishing agent then may be sprayed downward toward the plurality of battery assemblies 910 located below through a spraying device formed in the extinguishing pipe 940. In addition, in response to receiving a command from the battery control device 920 to stop extinguishing, the fire extinguishing device 930 may close the main valve to stop discharging the fire extinguishing agent.

With such a configuration, if a fire occurs in a specific battery assembly, a fire extinguishing agent may be sprayed at the container level. Accordingly, fire propagation between battery assemblies may be prevented.

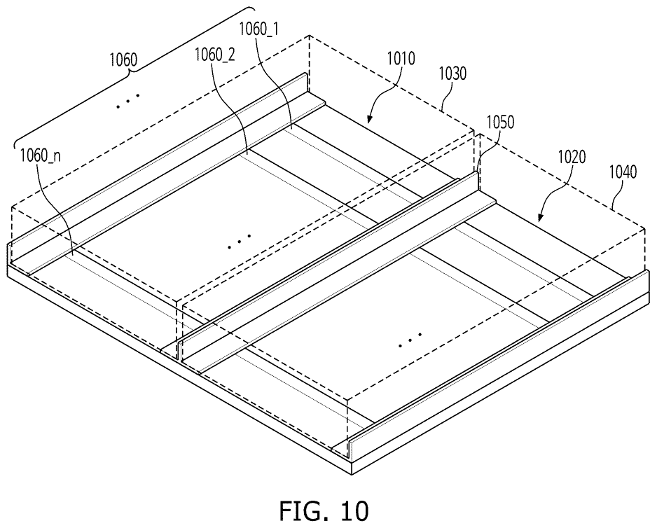

FIG. 10 illustrates an example of support members 1010 and 1020 of a battery container according to an embodiment of the present disclosure. The battery container may include a plurality of battery assemblies 1030 and 1040, support members 1010 and 1020 supporting lower portions of the plurality of battery assemblies 1030 and 1040, and side support members 1050 that protrude upward perpendicularly from the support members 1010 and 1020 and support side surfaces of the plurality of battery assemblies 1030 and 1040. The battery assemblies 1030 and 1040 may include a plurality of battery cells aligned in a first direction. In this case, the plurality of battery assemblies 1030 and 1040 may be aligned in a second direction perpendicular to the first direction. That is, a first battery assembly 1030 and a second battery assembly 1040 may be arranged in the second direction. In FIG. 10, for clarity, the plurality of battery assemblies 1030 and 1040 are omitted.

The support members 1010 and 1020 may include a cooling portion 1060 for cooling the plurality of battery assemblies 1030 and 1040. The cooling portion 1060 may include a plurality of cooling passages 1060_1 to 1060_n spaced apart from each other and accommodating a coolant. The cooling portion 1060 may extend in the second direction in which the plurality of battery assemblies 1030 and 1040 are aligned to cool the plurality of battery assemblies 1030 and 1040. That is, one or more cooling passages may extend in the second direction and cool the plurality of battery assemblies 1030 and 1040. The shape of the plurality of cooling passages 1060_1 to 1060_n mounted on the support members 1010 and 1020 is not limited to the depiction in FIG. 10, and a single cooling passage may be arranged in a circulating form.

With the depicted configuration, support members support the lower portions of the battery assemblies, and the battery assemblies may be cooled. Accordingly, the battery assemblies may be cooled and the heat dispersed, thereby preventing temperature imbalance among the battery cells included in the battery container.

Although the present disclosure has been described above with respect to embodiments thereof, the present disclosure is not limited thereto. Various modifications and variations can be made thereto by those skilled in the art within the spirit of the present disclosure.

### DESCRIPTION OF SOME REFERENCE SYMBOLS

10: battery cell
110: case
122: cap plate
124: vent portion
126: sealing stopper
130_1: positive electrode terminal
130_2: negative electrode terminal

What is claimed is:

1. A battery assembly comprising:
a case;
a plurality of battery cells accommodated in the case and aligned in one direction; and
a pusher coupled to an inside of the case and configured to push the plurality of battery cells in the one direction.

2. The battery assembly according to claim 1, wherein the case comprises:
a lower plate supporting lower portions of the battery cells; and
a side plate coupled orthogonally to the lower plate and supporting side surfaces of the battery cells.

3. The battery assembly according to claim 2, wherein the pusher is coupled to an inner surface of the side plate and is configured to push the plurality of battery cells in a direction facing the inner surface.

4. The battery assembly according to claim 3, wherein the pusher comprises:
a head contacting at least a portion of the plurality of battery cells; and
an elastic member having a first end connected to the inner surface and a second end connected to the head, the elastic member being configured to provide a restoring force to the head.

5. The battery assembly according to claim 2, wherein the lower plate comprises a cooling portion and a support portion supporting the cooling portion.

6. The battery assembly according to claim 5, wherein the cooling portion comprises a plurality of cooling passages, with the cooling passages being spaced apart from each other and being configured to accommodate a coolant.

7. The battery assembly according to claim 1, further comprising:
a plurality of bus bars configured to electrically connect the battery cells;
a bus bar holder positioned above the plurality of battery cells and configured to support the plurality of bus bars; and
a coupling member coupling the bus bar holder and the case.

8. The battery assembly according to claim 7, wherein the coupling member detachably couples the plurality of bus bars, the bus bar holder, and the case.

9. The battery assembly according to claim 7, wherein a first end of the coupling member is coupled to the bus bar holder and a second end of the coupling member is inserted into and coupled to a coupling groove formed in the case.

10. A battery container comprising:
a plurality of battery assemblies;
a plurality of slave battery management systems controlling the plurality of battery assemblies; and
a plurality of battery control devices connected to the plurality of slave battery management systems,
wherein each of the battery assemblies comprises:
a plurality of battery cells aligned in a first direction;
a case accommodating the plurality of battery cells; and
a pusher coupled to an inside of the case and configured to push the plurality of battery cells in the first direction.

11. The battery container according to claim 10, wherein the plurality of battery assemblies comprises:
a first set of battery assemblies aligned in a second direction perpendicular to the first direction; and
a second set of battery assemblies aligned in the second direction and disposed in a third direction with respect to the first set of battery assemblies,
wherein the third direction is perpendicular to each of the first direction and the second direction, and
wherein the plurality of slave battery management systems comprises:
a first set of slave battery management systems arranged on a front surface of each of the first set of battery assemblies and connected in the second direction; and
a second set of slave battery management systems arranged on a front surface of each of the second set of battery assemblies and connected in the second direction.

12. The battery container according to claim 11, wherein the plurality of battery control devices comprises:
a first battery control device connected in the second direction to the first set of slave battery management systems; and
a second battery control device connected in the second direction to the second set of slave battery management systems.

13. The battery container according to claim 12, wherein the first battery control device and the second battery control device are arranged and connected in the third direction.

14. The battery container according to claim 13, wherein the first battery control device is arranged at a center of the first set of battery assemblies aligned in the second direction, and the second battery control device is arranged at a center of the second set of battery assemblies aligned in the second direction.

15. The battery container according to claim 10, further comprising a fire extinguishing device accommodating a fire extinguishing agent, and
wherein in response to detecting a fire occurring in at least a portion of the plurality of battery assemblies, the plurality of battery control devices is configured to control the fire extinguishing device to spray the fire extinguishing agent onto the plurality of battery assemblies.

16. The battery container according to claim 10, wherein each of the plurality of battery control devices comprises:
a master battery management system configured to control at least a portion of the plurality of slave battery management systems; and
a power control unit configured to control power supplied to at least a portion of the plurality of battery assemblies.

17. The battery container according to claim 10, further comprising a support member supporting lower portions of the battery assemblies,
wherein the support member comprises a cooling portion configured to cool the plurality of battery assemblies.

18. The battery container according to claim 17, wherein the plurality of battery assemblies comprises:
a first battery assembly; and
a second battery assembly aligned in a second direction with respect to the first battery assembly,
wherein the second direction is perpendicular to the first direction, and
wherein the cooling portion extends in the second direction to cool the first battery assembly and the second battery assembly.

19. The battery container according to claim 10, wherein the case comprises:
a lower plate supporting lower portions of the battery cells; and
a side plate coupled orthogonally to the lower plate and supporting side surfaces of the battery cells.

20. The battery container according to claim 19, wherein the pusher is coupled to an inner surface of the side plate and is configured to push the plurality of battery cells in a direction facing the inner surface.
